(19) United States
(12) Patent Application Publication
(10) Pub. No.: US 2016/0229513 A1
(43) Pub. Date: Aug. 11, 2016

(54) AIRCRAFT TAIL CONE

(71) Applicants: Airbus Operations (SAS), Toulouse (FR); Airbus Operations GmbH, Hamburg (DE); Airbus Operations S.L., Getafe-Madrid (ES)

(72) Inventors: Henning Scheel, Hamburg (DE); Eric Bouchet, Aussonne (FR); Julien Guillemaut, Toulouse (FR); Esteban Martino-Gonzalez, Aranjuez (ES)

(21) Appl. No.: 15/018,481

(22) Filed: Feb. 8, 2016

(30) Foreign Application Priority Data
Feb. 9, 2015 (FR) 1551014

(51) Int. Cl. B64C 1/14; B64C 1/16; B64C 1/10

(52) U.S. Cl. CPC B64C 1/1446; B64C 1/10; B64C 1/16

(57) ABSTRACT

An aircraft tail cone comprising a fuselage in which avionic equipment is housed. The tail cone comprises two lateral hatches formed in the fuselage, at least one hatch being formed on each of the two opposite sides of the fuselage. Each hatch is mounted removably with respect to the fuselage so as to take up a closed first position in which the hatch closes a lateral opening in the fuselage, and an open second position in which the open hatch allows access to the inside of the tail cone through the corresponding opening The avionic equipment that requires regular inspection and/or maintenance operations is housed in a part of the tail cone which is accessible through the two lateral openings in the fuselage to a person who remains on the outside of the fuselage.

### CROSS-REFERENCES TO RELATED APPLICATIONS

This application claims the benefit of the French patent application No. 1551014 filed on Feb. 9, 2015, the entire disclosures of which are incorporated herein by way of reference.

### BACKGROUND OF THE INVENTION

The invention relates to an aircraft tail cone.

Most aircraft incorporate avionic equipment in their tail cone.

This equipment comprises, for example, the systems for powering the control surfaces situated in the empennage, etc.

In some aircraft, the engines are disposed at the tail cone of these aircraft.

Thus, the tail cone incorporates equipment in addition to that listed above, namely, systems for powering the engines and auxiliary power units (APU), fuel (kerosene) circuits, hydraulic and electrical circuits, air circuits that supply the cabin with hot air which is taken from the engines and cooled, fire extinguishing systems and equipment (cylinders containing extinguishing agent), etc.

In the type of aircraft with aft-mounted engines, the tail cone is relatively longer than on aircraft having wing-mounted engines so as to be able to incorporate all of the equipment mentioned above.

Generally, aircraft tail cones (for aircraft with aft-mounted engines and with wing-mounted engines) are equipped, under the fuselage, with an access hatch. Such a hatch allows qualified operators to pass inside the tail cone and carry out inspection and/or maintenance operations on all or some of the avionic equipment present. For some equipment, the operations have to be carried out regularly, for example before each flight or at regular intervals.

However, it is frequently difficult for the operators to move around inside the tail cone on account of the space taken up by the equipment and thus the little space that is left free for the movement of persons.

The accessibility of the equipment in the tail cone to operators for inspection and/or maintenance operations is thus greatly limited.

As a result, inspection and/or maintenance operations take time. The difficulty of access also increases the risk of the equipment being damaged during maintenance operations.

In light of the above, it would thus be useful to make inspection and/or maintenance operations of the equipment housed in an aircraft tail cone easier.

### SUMMARY OF THE INVENTION

Therefore, a subject of the present invention is an aircraft tail cone comprising a fuselage inside which avionic equipment is housed, characterized in that the tail cone comprises at least two lateral hatches which are formed in the fuselage, at least one lateral hatch being formed on each of the two opposite sides of the fuselage on either side of the longitudinal axis of the aircraft, the at least two lateral hatches each being mounted removably with respect to the fuselage so as to take up two positions, namely a closed first position in which each lateral hatch closes a lateral opening made in the fuselage, and an open second position in which each lateral hatch is open and allows access to the inside of the tail cone through the corresponding lateral opening, the avionic equipment which requires regular inspection and/or maintenance operations being housed in a part of the tail cone which is accessible from the outside of the fuselage through the two lateral openings in the fuselage.

The avionic equipment that requires regular inspection and/or maintenance operations is situated in a region of the tail cone which is accessible through each of the lateral openings made in the fuselage to a person who remains on the outside of the tail cone.

Most of this equipment is thus arranged in a region situated facing the lateral openings or in a region which is adjacent to this region and remains easily accessible from at least one of the openings.

According to further possible features considered in isolation or in combination with one another:
the aircraft tail cone comprises a pressure bulkhead which transversely closes off the upstream end of the tail cone;
the pressure bulkhead is provided with at least one access hatch which can take up a closed position in which the hatch closes a bulkhead opening made in the bulkhead and an open position allowing access to the inside of the tail cone through the bulkhead opening;
the tail cone comprises one or more engines connected to its fuselage;
two engines are connected to the fuselage on either side of the latter in each case by way of a pylon;
at least one lateral hatch is formed on each side under the corresponding pylon;
the at least two lateral hatches are structurally reinforced;
at least one of the at least two lateral hatches is involved in the transmission of force to the fuselage;
the at least one lateral hatch that is involved in the transmission of force to the fuselage comprises one or more panels which are each able to be opened and closed independently of one another;
the panel or panels are fixed to the fuselage in a removable manner;
the at least one lateral hatch that is involved in the transmission of force to the fuselage comprises at least one flap which has a size less than that of the at least one lateral hatch and is able to take up two positions, a closed first position in which the at least one flap closes an opening, known as the flap opening, which is made in the lateral hatch, and an open second position in which the at least one flap is open and allows access to the inside of the tail cone through the flap opening;
at least one of the at least two lateral hatches is not involved in the transmission of force to the fuselage;
the at least one lateral hatch is mounted so as to slide with respect to the fuselage;
the at least one lateral hatch is mounted in an articulated manner via a hinge system with respect to the fuselage.

A further subject of the invention is an aircraft, characterized in that it comprises an aircraft tail cone as briefly set out above.

### BRIEF DESCRIPTION OF THE DRAWINGS

Further features and advantages will become apparent from the following description, which is given solely by way of nonlimiting example and with reference to the appended drawings, in which:

FIG. 1 is an overall schematic view of an aircraft half;

FIG. 2 is an overall schematic front view of the aircraft from FIG. 1;

FIGS. 3a-c schematically illustrate an aircraft tail cone provided with lateral hatches according to a first embodiment of the invention;

FIG. 4 shows a perspective view of the inside of the tail cone of the aircraft from FIG. 1 in a view from the opposite side to the one illustrated in FIG. 1;

FIG. 5 is a schematic top view that shows, in a combined manner, for the purposes of comparison, the tail cone of the aircraft from FIGS. 1 to 3c on one side and the tail cone of a prior art aircraft on the opposite side;

FIGS. 6a-b schematically illustrate an aircraft tail cone provided with lateral hatches according to a second embodiment of the invention;

FIG. 7 is a schematic view of an aircraft tail cone according to a variant of the embodiment in FIGS. 3a-c;

FIGS. 8a-c schematically illustrate an aircraft tail cone provided with lateral hatches on the flat pressure bulkhead according to a third embodiment of the invention;

FIGS. 9a-c schematically illustrate an aircraft tail cone provided on each side with a sliding lateral hatch according to a fourth embodiment of the invention.

### DETAILED DESCRIPTION OF THE PREFERRED EMBODIMENTS

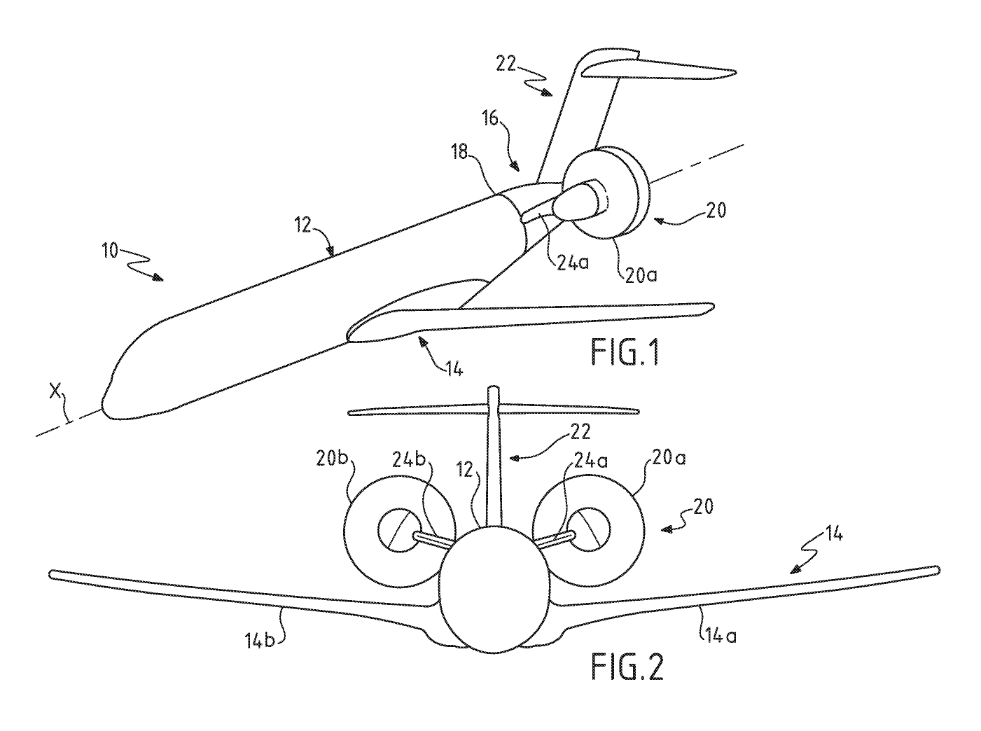

As shown in FIG. 1, only one half of an aircraft 10 according to a first embodiment of the invention is shown. The other half, which is not shown, is obtained by symmetry with respect to the axial vertical plane which contains the longitudinal axis X of the aircraft.

The aircraft comprises a fuselage 12, a central airfoil 14 connected to the fuselage and a tail cone 16. The tail cone 16 comprises the rear part of the fuselage 18, an aft-mounted engine 20 connected to the rear part of the fuselage 18 and an empennage 22.

The aft-mounted engine in this case comprises, for example, an engine with contrarotating fans that is connected to the tail cone 16 by a pylon 24a fixed to the side of the tail cone shown in FIG. 1.

FIG. 2 shows the two wings 14a, 14b of the airfoil and the two engines 20a, 20b that are connected to the tail cone 16 by a respective pylon 24a, 24b.

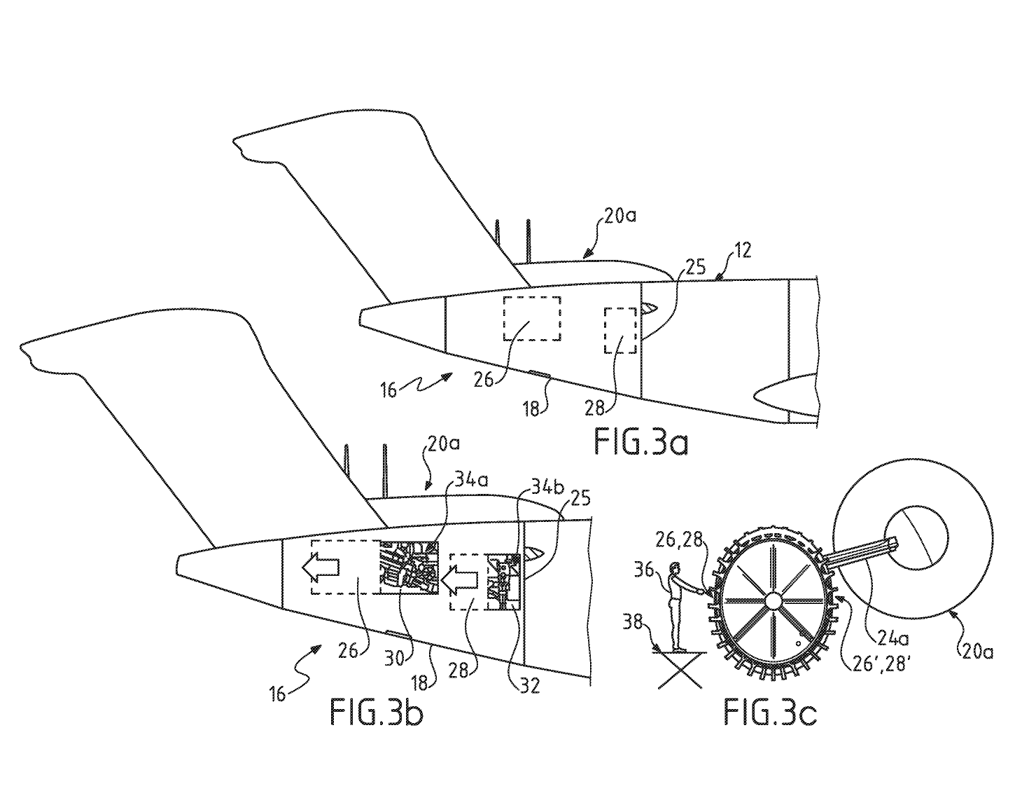

Only one of the two opposite sides of the fuselage is shown in FIGS. 3a-b, which illustrate the first embodiment in more detail: this is the opposite side to the one shown in FIG. 1. The following description relates to this side of the aircraft but is identical for the other side, which is symmetrical with respect to the vertical plane containing the longitudinal axis X.

The tail cone comprises two closed opposite ends, an upstream end and a downstream end that corresponds to the aft end of the aircraft.

As shown in FIG. 3a, the tail cone is delimited in its front part (at its upstream end) by a pressure bulkhead 25 (e.g., flat) that separates and closes the inside of the non-pressurized tail cone from the inside of the pressurized cabin fuselage. The tail cone comprises for instance two lateral hatches 26, 28 formed on one and the same side of the fuselage.

Each lateral hatch 26, 28 is mounted removably with respect to the fuselage so as to be able to take up at least two positions:
a closed first position (FIG. 3a) in which each lateral hatch 26, 28 closes a lateral opening made in the fuselage, and
an open second position in which each lateral hatch 26, 28 is open and allows access to the inside of the tail cone through the respective corresponding lateral opening 30, 32. In this example, the lateral openings and the lateral hatches have identical shapes and substantially corresponding dimensions. However, it is possible for the shapes and dimensions of the openings and hatches not to correspond. Thus, for example, one and/or the other hatch may have dimensions greater than those of the corresponding opening

The lateral hatch 28 is situated under the pylon 24b (FIG. 2) and the other, symmetrical lateral hatch 28′ is situated under the pylon 24a (FIG. 3c).

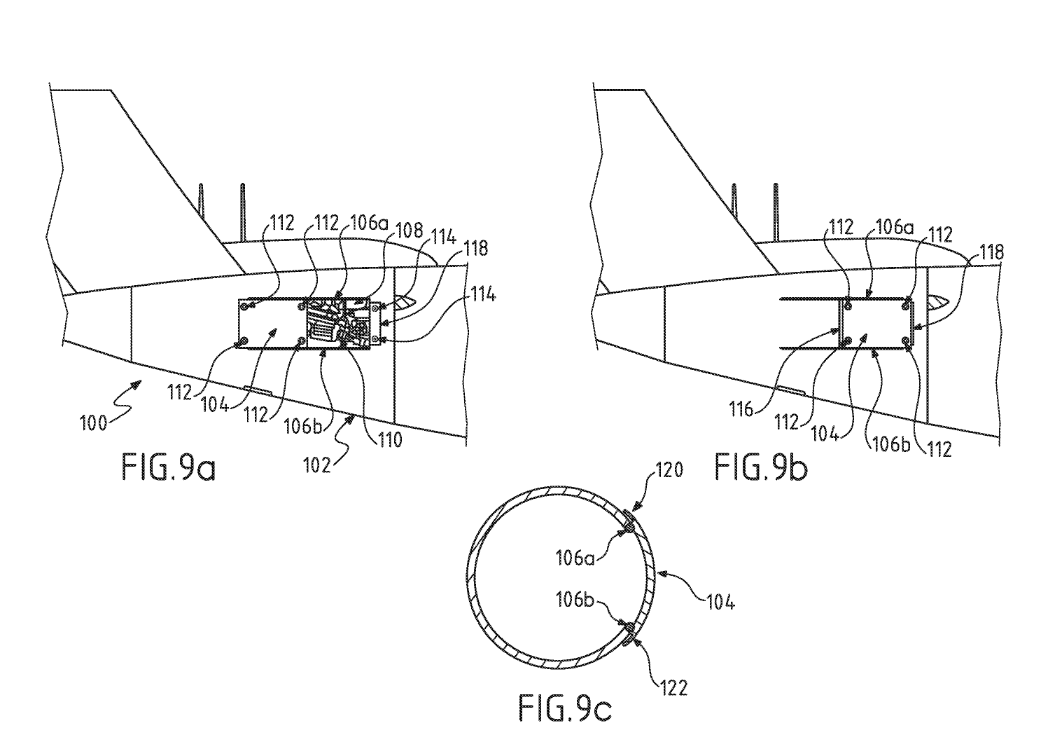

In this first embodiment, the lateral hatches are mounted so as to slide with respect to the fuselage in the manner known for the lateral doors of a helicopter and open towards the rear as in the latter. It will be noted that the system for fastening these hatches to the fuselage is much simpler than that of a passenger door of an aircraft since, in this case, it is not a question of a pressurized zone. The structure of these hatches and the manner in which they are mounted will be explained in more detail with reference to the fourth embodiment illustrated in FIGS. 9a-c.

The lateral hatches 26, 28 mounted in a sliding manner are “non-acting”, i.e., they are not involved in the transmission of force to the fuselage. These hatches are used when the inspection and/or maintenance operations are frequent.

The inside of the tail cone houses avionic equipment such as systems for powering the engines and auxiliary power units (APU), fuel (kerosene) circuits, hydraulic and electrical circuits, air-conditioning equipment and air circuits that supply the cabin with hot air which is taken from the engines and cooled, fire extinguishing systems and equipment (cylinders containing extinguishing agent), systems for powering the control surfaces that are situated in the empennage, computers, measurement systems (for example: the black boxes of the appliance, but also other types of sensors for carrying out possible measurements in flight), circuits for cooling the various fluids (oil, fuel), oil/fuel filters, systems for measuring fuel flow rates, any kind of valve for controlling the flow rates of these fluids, etc.

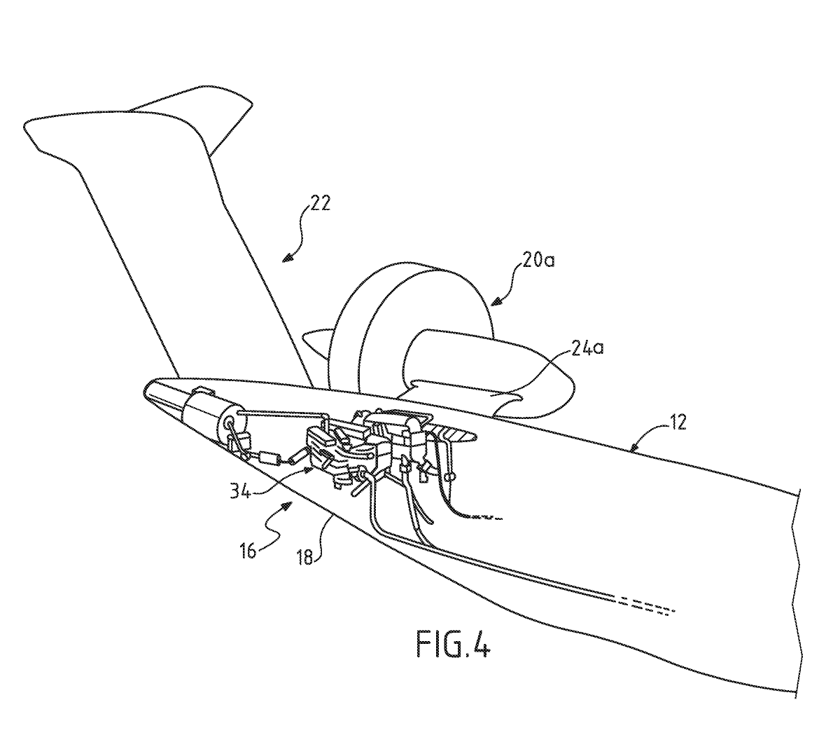

As shown in FIG. 4, an assembly 34 formed from at least some of this avionic equipment is formed in a part of the tail cone 16 at or in the vicinity of which the engine pylons 24a, 24b are fixed and at which the lateral hatches 26, 28, 26′, 28′ are provided.

The assembly 34 is housed in the tail cone downstream of the pressure bulkhead 25. Part of this assembly is situated in the vicinity of the pressure bulkhead. In the next embodiments an assembly of avionic equipment is also located behind the pressure bulkhead.

FIG. 3b shows that, when the lateral hatches 26, 28 are open, physical access from the outside of the aircraft to the equipment or to the plurality of equipment 34a, 34b situated facing the openings 30, 32 is possible for persons tasked with carrying out inspection and/or maintenance operations such as, for example, the person 36 in FIG. 3c standing on an elevator platform 38. These persons therefore no longer need to pass entirely inside the tail cone and to move around therein in order to carry out these operations. These persons merely need to lean into the inside of the tail cone in order to carry out their work. A person can also physically access the equipment that is situated around the equipment situated facing the openings 30, 32 and is at arm's reach when this person is partially inside the corresponding opening The pipes and various sections of wiring that connect this equipment together are not necessarily located behind the lateral hatches.

The avionic equipment which requires regular inspection and/or maintenance operations is thus housed in a part of the tail cone which is accessible from the outside of the fuselage through the four lateral openings in the fuselage.

By arranging the avionic equipment in such a way in this part of the tail cone, it is no longer necessary to provide, as in the prior art, an internal space in the tail cone for the movement of inspection and/or maintenance personnel. In the prior art, the avionic equipment in question was furthermore not collected together in this part of the tail cone and was sometimes even spread out within the tail cone. As a result, the internal dimensions and thus the external dimensions of the novel tail cone can be reduced.

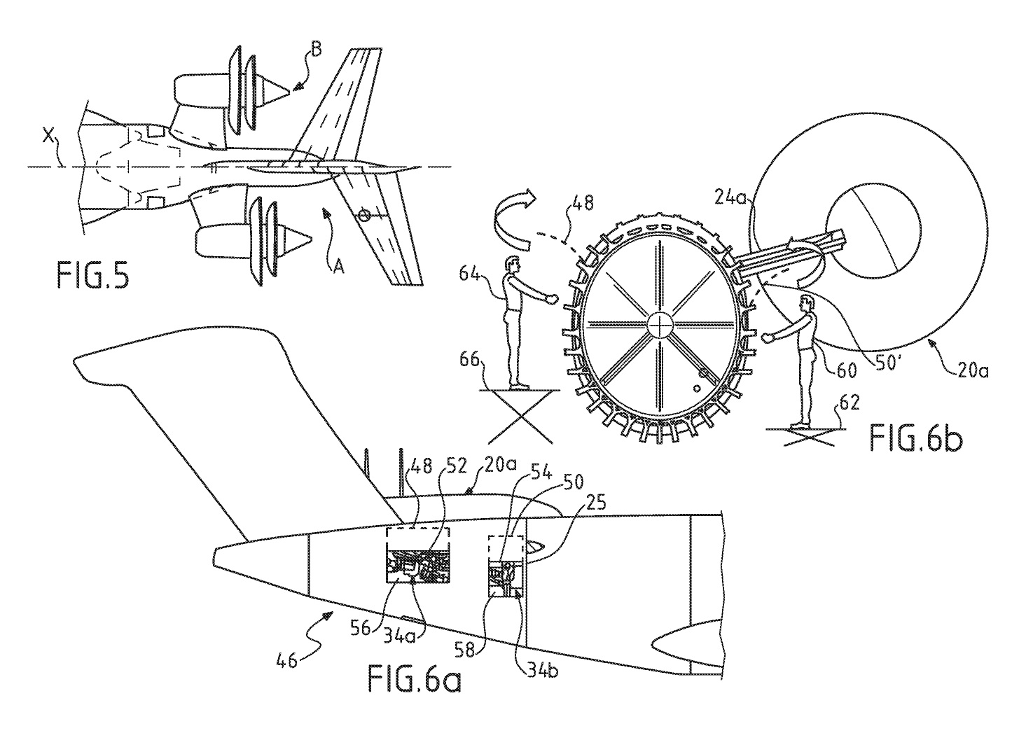

FIG. 5 illustrates, artificially combined in one and the same top view, a tail cone A of a prior art aircraft at the bottom and a tail cone B of an aircraft according to the embodiment of the invention in FIGS. 1 to 4 at the top.

This comparative view shows that the tail cone B is shorter and narrower (transverse dimension perpendicular to the longitudinal axis X) than the prior art tail cone A.

The shape and the dimensions of the lateral hatches and of their openings, and also the number and positions thereof are chosen in a suitable manner for the avionic equipment in the tail cone, for dimensions thereof and for the position thereof inside the fuselage. Thus, the openings are, in particular, dimensioned so as to allow the passage of equipment to be extracted from the tail cone or to be introduced into the latter.

It will be noted that the lateral hatches are structurally reinforced in a known manner so as to act as removable shields for protecting the avionic equipment inside the tail cone in the event of accidental loss of rotor blade(s) of each engine. The equipment situated behind these shields is thus protected, thereby making it possible to limit the systematic recourse to redundancy for all of the equipment with which the tail cone is equipped. A saving of on-board mass can thereby be obtained.

By way of example, the reinforced hatches are produced from the same material (for example aluminum, titanium) as that of the fuselage but with a greater thickness (for example, 5 to 15 mm, in particular, 10 mm) than that of the fuselage (for example, 1 to 3 mm) The thickness is chosen depending on the dimensions and the energy of the pieces of engine to be stopped. Alternatively, the material of the reinforced hatches can be based on carbon fibers or Kevlar.

In FIGS. 3a-b, the lateral hatches 26 and 28 are situated on different sides, the upstream hatch 28 being lower down than the downstream hatch 26. The opening 30 is rectangular but with a small length/width ratio so as to afford a section that covers an item or items of equipment 34a which extend over a rectangular surface area with a small length/width ratio. The opening 32, for its part, has a rectangular shape with a greater length/width ratio and a vertically disposed length so as to match the elongate shape of the equipment 34b.

It will be noted that the presence of a plurality of lateral hatches allows work to be carried out simultaneously on the avionic equipment inside the tail cone by way of all (saving of working time) or only some of these hatches.

According to a variant that is not shown, the lateral hatches slide forwards in order to be opened, thereby making it possible to afford additional safety as regards possible accidental opening in flight. However, the choice as to whether the hatches open towards the rear or towards the front depends in particular on the number and the position of all of the hatches (position of one hatch with respect to the others but also with respect to the pylon structure for supporting the engines).

FIGS. 6a-b illustrate a second embodiment of a tail cone 46 provided with two lateral hatches 48, 50 on each of the sides of the fuselage, as for the embodiment in FIGS. 3a-c. The shapes and dimensions of these hatches and the positions thereof are identical to those of the hatches in the embodiment in FIGS. 3a-c. The features described in relation to FIGS. 1, 2 and 4 apply to the embodiment in FIGS. 6a-b.

In this embodiment, the lateral hatches 48, 50 are each mounted in an articulated manner on the fuselage by way of a hinge system 52, 54 of the type used for the aircraft nacelle fairings.

The opening of the lateral hatches 48, 50 frees up respective corresponding lateral openings 56, 58, the features of which are identical to those in the embodiment in FIGS. 3a-c.

The lateral hatches 48, 50 mounted in an articulated manner are “non-acting”, i.e., they are not involved in the transmission of force to the fuselage. These hatches are used when the inspection and/or maintenance operations are frequent.

The lower position of the upstream hatches 50 and 50′ with respect to the downstream hatch 48 and to the symmetrical downstream hatch (not visible in the figures) allows them to be opened at the top while each being situated under the corresponding engine pylon 24b, 24a (FIG. 6b). A person 60 standing on a platform 62 can easily access the corresponding opening

The higher position of the downstream hatches 48 and 48′ with respect to the upstream hatches 50 and 50′ and outside the region situated vertically below the corresponding engine pylon 24b, 24a allows these downstream hatches to be opened at the top with no risk of interfering with the pylon (FIG. 6b). A person 64 standing on a platform 66 can easily access the corresponding opening.

According to a variant embodiment shown in FIG. 7, the lateral hatches of the tail cone 70 are “acting”, i.e., they are involved in the transmission of force to the fuselage.

As for the embodiments in the preceding figures, the tail cone comprises two lateral hatches 72, 74 on each side of the fuselage downstream of the pressure bulkhead 76 (e.g., flat).

Each lateral hatch can be formed by a single removable panel or a plurality of removable panels that are adjacent to one another and are each able to be opened and closed independently of one another.

In the example in FIG. 7, each lateral hatch comprises a single panel mounted removably on the outer face of the fuselage, for example, by way of bolts.

When necessary, each panel is removed and withdrawn in a simple manner without using complex tools in order to free up the opening which it covers (when it is mounted as shown in FIG. 7) and which has more or less the same dimensions as the panel. This allows access to the avionic equipment located behind the panel in question (such as the equipment 34a and 34b in FIG. 3b).

When the inspection and/or maintenance of avionic equipment is carried out more regularly (for example, upon each flight), it is not desirable to remove and refit the removable panel(s).

Thus, each lateral hatch comprises one or more “non-acting” secondary hatches or flaps that each have a size smaller than that of the main hatch or of the panel which forms the latter.

In FIG. 7, there are two flaps 72a-b, 74a-b per respective hatch/panel 72, 74.

Each flap is able to take up two positions, a closed first position in which the flap closes an opening, known as the flap opening, which is made in the lateral hatch/panel, and an open second position in which the flap is open and allows access to the inside of the tail cone through the flap opening In FIG. 7, the flaps are mounted in a sliding manner on the hatch/panel and are shown in the open position by way of dotted lines.

These flaps of reduced dimensions make it possible, without it being necessary to remove and withdraw the corresponding hatch/panel, to see and access some of the equipment which is disposed behind the hatch and requires frequent work and/or inspections, for instance upon each flight.

The lateral hatches 72, 74 that act in a structural manner allow a saving of on-board weight to be achieved compared with non-structural lateral hatches for which the fuselage needs to be reinforced significantly around the hatches, in the same way as for a passenger door or cargo door.

In order to simplify the operations of removing and refitting the lateral hatches in the event of work being carried out, it is preferable to produce each hatch in the form of a plurality of fittable/removable panels, each with a reduced size, which will be easier to handle individually. Moreover, it is conceivable to only withdraw the necessary panel(s) for the work to be carried out and not, systematically, all of the panels.

In FIG. 7, for example, four removable lateral panels P1 to P4 have been shown for the lateral hatch 72.

As in the case of the embodiments in FIGS. 1 to 6b, the number and/or position and/or size of the lateral hatches can vary. For example, a single lateral hatch or more than two lateral hatches on each side of the tail cone are conceivable.

It will be noted that the size, the number and the position of the flaps can vary depending on the arrangement of the equipment situated behind the hatch in question, the number thereof and the size thereof.

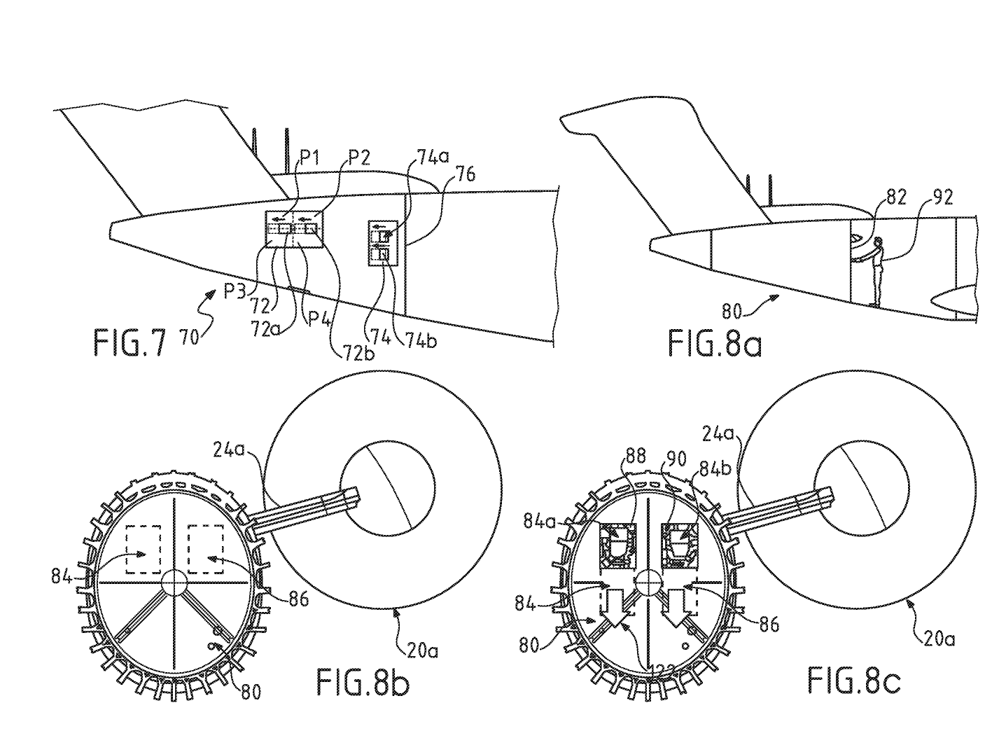

FIGS. 8a-c illustrate another embodiment of a tail cone 80 in which the pressure bulkhead 82 (e.g., flat) transversely closing off the upstream end of the tail cone is provided with two access hatches 84, 86.

Each hatch can take up a closed position in which the hatch closes a bulkhead opening that is made in the bulkhead, and an open position allowing access to the inside of the tail cone through the bulkhead opening

In this example, each hatch 84, 86 is mounted so as to slide on the bulkhead with a top closed position (FIG. 8b) and a bottom open position freeing up a bulkhead opening 88, 90 (FIG. 8c).

A person 92 situated in front of the bulkhead 82 and tasked with carrying out inspection and/or maintenance operations (FIG. 8a) can thus work, through one and/or the other of the bulkhead openings 88, 90, on the avionic equipment 84a, 84b accessible through the opening in question (FIG. 8c).

The bulkhead 82 equipped in this way can be part of tail cones of the embodiments in FIGS. 3a-c, 6a-b and 7 so as to allow better access to the avionic equipment in the tail cone (in addition to the lateral hatches) and thereby to optimize the internal arrangement thereof in order to reduce the volume of the tail cone. Moreover, there is thus greater accessibility to the avionic equipment in the tail cone since it is possible from three sides. It will be noted, however, that when the bulkhead 82 is provided with the hatches 84, 86, it is possible to have only a single lateral hatch on each side of the aircraft instead of two as in FIGS. 3a-c, 6a-b and 7.

It will be noted that the presence of additional access hatches in the flat bulkhead makes it possible to reduce the dimensions of the lateral hatches situated on the two sides of the fuselage.

The embodiment in FIGS. 9a-c illustrates an aircraft tail cone 100 equipped on each side of the fuselage 102 with a lateral hatch 104 that is mounted so as to slide on the fuselage in a manner opening towards the rear (the principle is the same if the hatch opens towards the front). The hatch 104 is mounted so as to slide on two parallel rails: an upper rail 106a and a lower rail 106b that are fixed at the upper edge and the lower edge, respectively, of an opening 108 made in the fuselage (along these edges). Avionic equipment 110 housed facing the opening 108 is accessible through the latter from the outside when the hatch is in the open position (FIG. 9a). The panel forming the hatch 104 is equipped with locking pins 112, of which there are for example four, which are inserted (in the closed position of the hatch in FIG. 9b) into locking housings or holes 114 (of which there are four, corresponding to the pins; only two holes are shown in FIG. 9a, the two others being concealed by the panel) in order to fix the panel in the closed position. The holes 114 are formed in structural uprights 116, 118 that are disposed respectively along the two lateral edges of the opening (rear edge 116 and front edge 118 in FIGS. 9a and 9b) in a manner adjacent to the upper and lower edges thereof.

An upper aerodynamic cowl 120 and a lower aerodynamic cowl 122 extend from the upper edge and lower edge, respectively, of the panel 104, meeting the fuselage so as to reduce the parasitic drag produced by outward projections of the sliding panel at the rails 106a and 106b. FIG. 9c illustrates this formation in a view taken from the rear of the aircraft and shows the curved shape of the panel 104. Further aerodynamic cowls (not shown in the figures) are also mounted on the adjacent front and rear edges of the panel 104 so as to reduce the parasitic drag produced by the outward projections of the sliding panel at the rear upright 116 and front upright 118 and the locking pins 112.

According to a variant that is not shown, one of the two lateral hatches in FIGS. 3a-c and 6a-b is configured to be involved in the transmission of force to the fuselage, as for the variant in FIG. 7.

According to another variant that is not shown, one of the two lateral hatches in FIGS. 3a-c and 6a-b is mounted so as to slide (for example the one situated under the pylon) while the other (for example the one situated next to the pylon) is mounted so as to pivot by way of a hinge system.

This difference in mounting makes it possible to modify the position of the hatches, in particular in terms of height.

It will be noted that the number of hatches shown in the various embodiments can vary, in particular be increased or reduced, depending on the application.

Although the lateral hatches and those (optional) in the flat pressure bulkhead have been described in relation to a tail cone of an aircraft with aft-mounted engines, any type of aircraft can be equipped therewith.

Any type of aircraft engine is suitable, namely a turboprop engine, a turbojet engine, an unducted engine with contrarotating fans, etc.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A tail cone of an aircraft, the tail cone comprising:
a fuselage inside of which avionic equipment is housed, and
at least two lateral hatches formed in the fuselage,
at least one of the at least two lateral hatches being formed on each of two opposite sides of the fuselage on either side of a longitudinal axis of the aircraft,
said at least two lateral hatches each being mounted removably with respect to the fuselage so as to alternately take up one of two positions, namely, a closed first position in which each lateral hatch closes one of two lateral openings made in the fuselage, and an open second position in which each lateral hatch is open and allows access to an inside of the tail cone through a corresponding one of the two lateral openings,
the avionic equipment, requiring at least one of regular inspection or maintenance operations, being housed in a part of the tail cone which is accessible from an outside of the fuselage through at least one of the two lateral openings in the fuselage.

2. The aircraft tail cone according to claim 1, further comprising a pressure bulkhead which transversely closes off a forward end of the tail cone.

3. The aircraft tail cone according to claim 2, wherein the pressure bulkhead is provided with at least one access hatch which can take up a closed position in which the access hatch closes a bulkhead opening made in the bulkhead and an open position allowing access to the inside of the tail cone through said bulkhead opening

4. The aircraft tail cone according to claim 1, wherein the tail cone comprises one or more engines connected to the fuselage.

5. The aircraft tail cone according to claim 4, wherein two engines are connected to the fuselage on either side of the fuselage, in each case by way of a pylon.

6. The aircraft tail cone according to claim 5, wherein at least one lateral hatch is formed on each side of the fuselage under a corresponding pylon.

7. The aircraft tail cone according to claim 1, wherein said at least two lateral hatches are structurally reinforced.

8. The aircraft tail cone according to claim 1, wherein at least one of said at least two lateral hatches is involved in the transmission of force to the fuselage.

9. The aircraft tail cone according to claim 8, wherein said at least one lateral hatch that is involved in the transmission of force to the fuselage comprises one or more panels which are each able to be opened and closed independently of one another.

10. The aircraft tail cone according to claim 9, wherein the one or more panels is fixed to the fuselage in a removable manner

11. The aircraft tail cone according to claim 8, wherein said at least one lateral hatch that is involved in the transmission of force to the fuselage comprises at least one flap which has a size less than that of said at least one lateral hatch and is able to take up two positions, a closed first position in which said at least one flap closes an opening, known as the flap opening, which is made in the lateral hatch, and an open second position in which said at least one flap is open and allows access to the inside of the tail cone through the flap opening

12. The aircraft tail cone according to claim 1, wherein at least one of said at least two lateral hatches is not involved in the transmission of force to the fuselage.

13. The aircraft tail cone according to claim 12, wherein said at least one lateral hatch not involved in the transmission of force is mounted so as to slide with respect to the fuselage.

14. The aircraft tail cone according to claim 12, wherein said at least one lateral hatch is mounted in an articulated manner via a hinge system with respect to the fuselage.

15. An aircraft comprising a tail cone, the tail cone comprising:
a fuselage inside of which avionic equipment is housed, and
at least two lateral hatches formed in the fuselage,
at least one of the at least two lateral hatches being formed on each of two opposite sides of the fuselage on either side of a longitudinal axis of the aircraft,
said at least two lateral hatches each being mounted removably with respect to the fuselage so as to alternately take up one of two positions, namely, a closed first position in which each lateral hatch closes one of two lateral openings made in the fuselage, and an open second position in which each lateral hatch is open and allows access to an inside of the tail cone through a corresponding one of the two lateral openings,
the avionic equipment, requiring at least one of regular inspection or maintenance operations, being housed in a part of the tail cone which is accessible from an outside of the fuselage through at least one of the two lateral openings in the fuselage.
